(19) United States
(12) Patent Application Publication
(10) Pub. No.: US 2026/0086368 A1
(43) Pub. Date: Mar. 26, 2026

(54) Head-Mounted Device Lens Modules

(71) Applicant: Apple Inc., Cupertino, CA (US)

(72) Inventors: Ivan S. Maric, Campbell, CA (US); Aidan N. Zimmerman, Poway, CA (US); Aditi G. Kanhere, San Jose, CA (US); Zachary A. Granger, Redwood City, CA (US); Blake N. Trekell, San Francisco, CA (US); Guanjun Tan, Campbell, CA (US); William W. Sprague, San Francisco, CA (US); Dagny Fleischman, Campbell, CA (US); Fuyi Yang, San Jose, CA (US)

(21) Appl. No.: 19/276,947

(22) Filed: Jul. 22, 2025

Related U.S. Application Data
(60) Provisional application No. 63/697,963, filed on Sep. 23, 2024.

(51) Int. Cl. G02B 27/01; G02B 27/28

(52) U.S. Cl. CPC G02B 27/0172; G02B 27/286; G02B 2027/0178

(57) ABSTRACT

An electronic device may include a display and a lens assembly that are supported by a housing. The lens assembly may include multiple lenses. The lenses and/or the display may include a polarizer to mitigate artifacts associated with a double bounce path of light through the optical system. The polarizers may include quarter wave plates and half wave plates. A polarizer in the lens assembly may have a polarization axis aligned with a polarization axis of polarizer in the display. The display may also include a geometric phase lens, which may redirect light from the display. Additionally or alternatively, the housing may be coated with a low-visible-reflectance-and-low-infrared-reflectance coating, which may further increase the contrast of the display.

This application claims the benefit of U.S. provisional patent application No. 63/697,963, filed Sep. 23, 2024, which is hereby incorporated by reference herein in its entirety.

### BACKGROUND

This relates generally to optical systems, including optical systems for head-mounted displays.

Head-mounted displays such as virtual reality glasses use lenses to display images for a user. A display may create images for each of a user's eyes. A lens may be placed between each of the user's eyes and a portion of the display so that the user may view virtual reality content.

### SUMMARY

An electronic device may include a display and a lens assembly that are supported by a housing. The lens assembly may include multiple lenses, such as catadioptric lenses. The lenses and/or the display may include a polarizer to mitigate artifacts associated with a double bounce path of light causing ghosting through the optical system.

The polarizers may include quarter wave plates and half wave plates. A polarizer in the lens assembly may have a polarization axis aligned with a polarization axis of polarizer in the display. The polarizers may serve as retarders and may reduce ghosting within the optical system.

The display may also include a geometric phase lens, which may redirect light from the display depending on the location of the light on the lens and/or the polarization of the light when it reaches the lens.

Additionally or alternatively, the housing may be coated with a low-visible-reflectance-and-low-infrared-reflectance coating, which may further increase the contrast of the display.

### BRIEF DESCRIPTION OF THE DRAWINGS

FIG. 1 is a diagram of an illustrative electronic device in accordance with some embodiments.

FIG. 2 is a cross-sectional side view of an illustrative electronic device with a lens module that includes a lens assembly and a display in accordance with some embodiments.

FIG. 3 is a side view of an illustrative lens assembly including a polarizer between first and second lenses in accordance with some embodiments.

FIG. 4 is a side view of an illustrative display including a polarizer and a geometric phase lens overlapping a display layer in accordance with some embodiments.

FIG. 5 is a front view of an illustrative geometric phase lens in accordance with some embodiments.

FIGS. 6A and 6B are illustrative diagrams of light with different polarizations passing through a geometric phase lens in accordance with some embodiments.

FIG. 7 is a diagram of an illustrative lens assembly and display with polarizers and additional optical layers in accordance with some embodiments.

FIG. 8 is a side view of an illustrative support that houses a lens assembly and a display in accordance with some embodiments.

FIG. 9 is a front view of an illustrative portion of a support coated with a low-visible-reflectance-and-low-infrared-reflectance coating in accordance with some embodiments.

### DETAILED DESCRIPTION

Head-mounted displays may be used for virtual reality and/or augmented reality systems. For example, a pair of virtual reality glasses or goggles that is worn on the head of a user may be used to provide a user with virtual reality content and/or augmented reality content.

The head-mounted displays may be mounted in optical modules that include lens assemblies that pass images generated by the head-mounted displays to eye boxes for viewing by the user. Each assembly may include multiple lenses. To reduce or eliminate ghosting due to double-bouncing within the lens assembly and/or additional reflections within the lens assembly, one or more polarizers may be incorporated into the lens assembly and/or each display.

In particular, the lens assembly may include a first lens and a second lens, the first lens between the second lens and the display. A quarter wave plate and a half wave plate may form a polarizer in the lens assembly between the first lens and the second lens. Similarly, the display may include an additional quarter wave plate and an additional half wave plate to form a polarizer through which the display emits the images. The polarizer in the lens assembly may have the same polarization axis as the polarizer in the display (e.g., the two polarization axes may match and/or may be aligned).

Alternatively or additionally, the display may include a geometric phase lens through which the display emits the images. The geometric phase lens may redirect light emitted by the display by different amounts depending on how close the light is to the center of the lens and/or depending on the polarization of light passing through the geometric phase lens.

The optical modules in which the displays and lens assemblies are mounted may include one or more low-visible-reflectance-and-low-infrared-reflectance coatings. These coatings may be ultrablack coatings and/or may have low specular and low diffuse reflection at visible and infrared wavelengths. In general, by reducing the ghosting in the lens assemblies, matching the polarization of the displays and the lens assemblies, and/or incorporating low-reflectance coatings into the optical modules, the contrast of the optical modules may be increased.

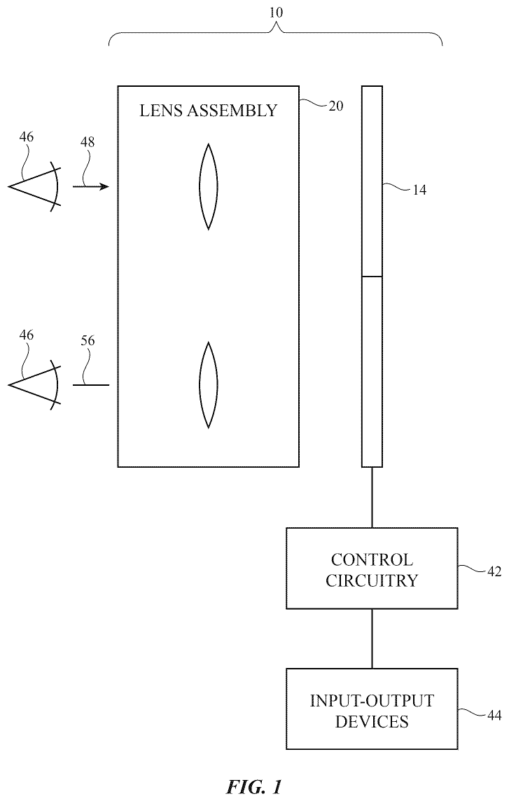

An illustrative system in which an electronic device (e.g., a head-mounted display such as a pair of virtual reality glasses or goggles) is used in providing a user with virtual reality content with optical modules is shown in FIG. 1. As shown in FIG. 1, electronic device 10 (sometimes referred to as glasses 10, virtual reality glasses 10, head-mounted display 10, device 10, head-mounted device 10, etc.) may include a display such as display 14 that creates images and may have an optical system such as lens assembly 20 (also referred to as lens system 20 and/or lenses 20 herein) through which a user (see, e.g., user's eyes 46) may view the images produced by display 14 by looking in direction 48. Although device 10 is shown as glasses, this is merely illustrative. In general, device 10 may be another virtual reality, mixed reality, and/or augmented reality device, such as a goggles-type head-mounted device.

Each eye 46 may have a corresponding eye box (e.g., an expected location of the user's eye when head-mounted device 10 is worn by the user). Eyes 46 may therefore sometimes be referred to as eye boxes 46.

Display 14 (sometimes referred to as display panel 14 or display system 14) may be based on a liquid crystal display, an organic light-emitting diode display, an emissive display having an array of crystalline semiconductor light-emitting diode dies (e.g., a microLED display), and/or displays based on other display technologies. Separate left and right displays 14 may be included in device 10 for the user's left and right eyes, respectively, or a single display 14 may span both eyes.

Visual content (e.g., image data for still and/or moving images) may be provided to display 14 using control circuitry 42 that is mounted in device 10 and/or control circuitry that is mounted outside of device 10 (e.g., in an associated portable electronic device, laptop computer, or other computing equipment). Control circuitry 42 may include storage such as hard-disk storage, volatile and non-volatile memory, electrically programmable storage for forming a solid-state drive, and other memory. Control circuitry 42 may also include one or more microprocessors, microcontrollers, digital signal processors, graphics processors, baseband processors, application-specific integrated circuits, and other processing circuitry. Communications circuits in circuitry 42 may be used to transmit and receive data (e.g., wirelessly and/or over wired paths). Control circuitry 42 may use display 14 to display visual content such as virtual reality content (e.g., computer-generated content associated with a virtual world), pre-recorded video for a movie or other media, or other images. Illustrative configurations in which control circuitry 42 provides a user with virtual reality content using display 14 may sometimes be described herein as an example. In general, however, any suitable content, including augmented reality content, mixed reality content, passthrough content, and/or other content, may be presented to a user by control circuitry 42 using display 14 and lens assembly 20 of device 10.

Input-output devices 44 may be coupled to control circuitry 42. Input-output devices 44 may be used to gather user input from a user, may be used to make measurements on the environment surrounding device 10, may be used to provide output to a user, and/or may be used to supply output to external electronic equipment. Input-output devices 44 may include buttons, joysticks, keypads, keyboard keys, touch sensors, track pads, displays, touch screen displays, microphones, speakers, light-emitting diodes for providing a user with visual output, sensors (e.g., a force sensors, temperature sensors, magnetic sensor, accelerometers, gyroscopes, and/or other sensors for measuring orientation, position, and/or movement of device 10, proximity sensors, capacitive touch sensors, strain gauges, gas sensors, pressure sensors, ambient light sensors, and/or other sensors). If desired, input-output devices 44 may include one or more cameras/optical sensors (e.g., cameras for capturing images of the user's surroundings, cameras for performing gaze detection operations by viewing eyes 46, and/or other cameras).

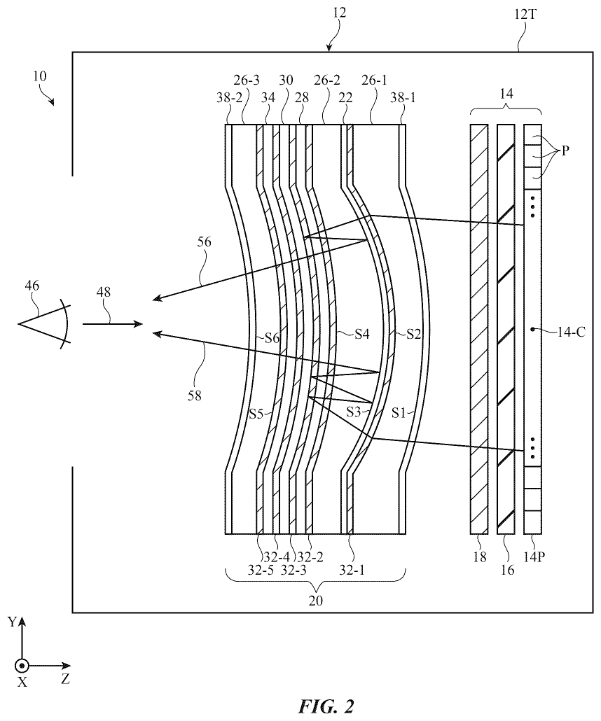

FIG. 2 is a cross-sectional side view of device 10 showing how lens assembly 20 and display 14 may be supported by and/or coupled to head-mounted support structures such as housing 12 for device 10. Housing 12 may have the shape of a frame for a pair of glasses (e.g., device 10 may resemble eyeglasses), may have the shape of a helmet (e.g., device 10 may form a helmet-mounted display), may have the shape of a pair of goggles, or may have any other suitable housing shape that allows housing 12 to be worn on the head of a user. Configurations in which housing 12 supports lens assembly 20 and display 14 in front of a user's eyes (e.g., eyes 46) as the user is viewing lens assembly 20 and display 14 in direction 48 may sometimes be described herein as an example. If desired, housing 12 may have other desired configurations.

Although not shown in FIG. 2 for clarity, lens assembly 20 and/or display 14 may be mounted in an optical module, such as a lens barrel (also referred to as a support or support structure herein). Additionally or alternatively, device 10 may include two optical modules (e.g., one for each of user's eyes 46), each of which has a display 14 and an associated lens assembly 20.

Housing 12 may be formed from plastic, metal, fiber-composite materials such as carbon-fiber materials, wood and other natural materials, glass, other materials, and/or combinations of two or more of these materials.

Input-output devices 44 and control circuitry 42 (FIG. 1) may be mounted in housing 12 with lens assembly 20 and display 14 and/or portions of input-output devices 44 and control circuitry 42 may be coupled to device 10 using a cable, wireless connection, or other signal paths.

Display 14 and the optical components of device 10 may be configured to display images for eyes 46 of the user using a lightweight and compact arrangement. Lens assembly 20 may, for example, be based on catadioptric lenses (e.g., lenses that use both reflecting and refracting of light).

Display 14 may include a source of images such as pixel array 14P (also referred to as display layer 14P herein). Display layer 14P may include a two-dimensional array of pixels P that emits image light (e.g., organic light-emitting diode pixels, light-emitting diode pixels formed from semiconductor dies, liquid crystal display pixels with a backlight, liquid-crystal-on-silicon pixels with a frontlight, etc.). A polarizer such as linear polarizer 16 may be placed in front of pixel array 14P and/or may be laminated to pixel array 14P to provide polarized image light. Linear polarizer 16 may have a pass axis aligned with the Y-axis of FIG. 2 (as an example). Display 14 may also include a wave plate such as quarter wave plate 18 (also referred to as retarder 18 herein) to provide circularly polarized image light. The fast axis of quarter wave plate 18 may be aligned at 45 degrees relative to the pass axis of linear polarizer 16. Quarter wave plate 18 may be mounted in front of polarizer 16 (between polarizer 16 and lens assembly 20). If desired, quarter wave plate 18 may be attached to polarizer 16 (and display 14).

Lens assembly 20 may include lens elements (sometimes referred to simply as lenses) such as lenses 26-1, 26-2, and 26-3. Each lens may be formed from a transparent material such as plastic, glass, acrylic, polycarbonate, sapphire, etc. The lenses may sometimes be formed using molding (e.g., molded plastic or molded glass). Lens 26-1 may have a surface S1 that faces display 14 and a surface S2 that faces the user (e.g. eyes 46). Lens 26-2 may have a surface S3 that faces display 14 and a surface S4 that faces the user (e.g. eyes 46). Lens 26-3 may have a surface S5 that faces display 14 and a surface S6 that faces the user (e.g. eyes 46). Each one of surface S1, S2, S3, S4, S5, and S6 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. Herein, a freeform surface that is primarily convex may sometimes still be referred to as a convex surface and a freeform surface that is primarily concave may sometimes still be referred to as a concave surface.

In one illustrative arrangement, shown in FIG. 2, surface S1 is an aspheric convex surface, surface S2 is an aspheric concave surface, surface S3 is an aspheric convex surface, surface S4 is an aspheric concave surface, surface S5 is an aspheric convex surface, and surface S6 is an aspheric concave surface.

Optical structures such as partially reflective coatings, wave plates, reflective polarizers, linear polarizers, antireflection coatings, and/or other optical components may be incorporated into device 10 (e.g., into lens assembly 20 and/or display 14). These optical structures may allow light rays from display 14 to pass through and/or reflect from surfaces in lens assembly 20, thereby providing lens assembly 20 with a desired lens power.

As shown in FIG. 2, a first coating 38-1 may be formed on the aspheric convex surface S1 of lens element 26-1. Coating 38-1 may be an anti-reflective coating (ARC), anti-smudge (AS) coating, or any other desired coating.

A partially reflective mirror (e.g., a metal mirror coating or other mirror coating such as a dielectric multilayer coating with a 50% transmission and a 50% reflection) such as partially reflective mirror 22 may be formed on the aspheric convex surface S3 of lens element 26-2. Partially reflective mirror 22 may sometimes be referred to as beam splitter 22, half mirror 22, or partially reflective layer 22.

A wave plate such as wave plate 28 may be attached to the aspheric concave surface S4 of lens element 26-2. Wave plate 28 (sometimes referred to as retarder 28, quarter wave plate 28, etc.) may be a quarter wave plate that conforms to surface S4 of lens element 26-2. In some embodiments, retarder 28 may be a coating on surface S4 of lens element 26-2.

Retarder 28 in FIG. 2 may have aspheric curvature (e.g., curvature along multiple axes and with different radii of curvature) with a relatively uniform thickness to provide a relatively uniform retardation. Retardation is equal to the thickness of the retarder multiplied by the birefringence of the retarder material. The thickness of retarder 28 may be relatively uniform across the optical system (lens assembly). As specific examples, the retardation provided by retarder 28 across the entire retarder may be uniform within 20%, within 10%, within 5%, within 3%, within 2%, within 1%, etc. Similarly, the thickness of retarder 28 across the entire retarder may be uniform within 20%, within 10%, within 5%, within 3%, within 2%, within 1%, etc. In other words, the retardation variation across the retarder is no more than 20%, no more than 10%, no more than 5%, no more than 3%, no more than 2%, no more than 1%, etc. The thickness variation across the retarder is no more than 20%, no more than 10%, no more than 5%, no more than 3%, no more than 2%, no more than 1%, etc.

Reflective polarizer 30 may be attached to retarder 28. Reflective polarizer 30 may have orthogonal reflection and pass axes. Light that is polarized parallel to the reflection axis of reflective polarizer 30 will be reflected by reflective polarizer 30. Light that is polarized perpendicular to the reflection axis and therefore parallel to the pass axis of reflective polarizer 30 will pass through reflective polarizer 30.

Polarizer 34 may be attached to reflective polarizer 30. Polarizer 34 may be a linear polarizer. Polarizer 34 may be referred to as an external blocking linear polarizer 34 or cleanup polarizer 34. Linear polarizer 34 may have a pass axis aligned with the pass axis of reflective polarizer 30. Linear polarizer 34 may have a pass axis that is orthogonal to the pass axis of linear polarizer 16.

The thickness of linear polarizer 34 across the entire polarizer may be uniform within 20%, within 10%, within 5%, within 3%, within 2%, within 1%, etc. The thickness variation across the linear polarizer may be no more than 20%, no more than 10%, no more than 5%, no more than 3%, no more than 2%, no more than 1%, etc.

A second coating 38-2 may be formed on the aspheric concave surface S6 of lens element 26-3. Coating 38-2 may be an anti-reflective coating (ARC), anti-smudge (AS) coating, or any other desired coating.

As shown in FIG. 2, one or more layers of adhesive may be included in lens assembly 20 to attach adjacent components within the optical system. In the example of FIG. 2, five layers of adhesive (e.g., adhesive layer 32-1, adhesive layer 32-2, adhesive layer 32-3, adhesive layer 32-4, and adhesive layer 32-5) are included. Each adhesive layer may be an optically clear adhesive (OCA) layer with a transparency of greater than 80%, greater than 90%, greater than 95%, greater than 99%, etc.

Adhesive layer 32-1 is interposed between partially reflective layer 22 and lens element 26-1. Adhesive layer 32-2 is interposed between retarder 28 and lens element 26-2. Adhesive layer 32-3 is interposed between reflective polarizer 30 and retarder 28. Adhesive layer 32-4 is interposed between linear polarizer 34 and reflective polarizer 30. Adhesive layer 32-5 is interposed between lens element 26-3 and linear polarizer 34.

The lens assembly 20 may be formed as a single, solid lens assembly without any intervening air gaps. As shown in FIG. 2, each layer in lens assembly 20 is attached directly to the adjacent layers. The example of attaching adjacent components in lens assembly 20 using adhesive layers is merely illustrative. In general, layers in lens assembly 20 may instead be formed as coatings directly on an adjacent layer (and thus the intervening adhesive layer may be omitted). As a specific example, quarter wave plate 28 may be formed as a coating on lens element 26-2 and adhesive layer 32-2 may be omitted if desired. Reflective polarizer 30 and linear polarizer 34 may also be formed as coatings if desired. However, this is merely illustrative. In some embodiments, air gaps may be incorporated into lens assembly 20.

Linear polarizer 34 has a pass axis aligned with the pass axis of reflective polarizer 30 (e.g., parallel to the Y-axis) so that any light from the external environment will be polarized by linear polarizer 34 such that light is not reflected by the reflective polarizer 30. Light that is transmitted by the linear polarizer 34 and the reflective polarizer 30 may pass through retarders 28 and 18 and be absorbed by linear polarizer 16.

Including lens element 26-1 (between the partially reflective layer 22 and display 14) in the optical system of FIG. 2 may advantageously remove the refractive contribution of partially reflective layer 22 and enable a larger field-of-view for a given display system. Additionally, in the optical system of FIG. 2 the functional optical layers (e.g., partially reflective layer 22, retarder 28, reflective polarizer 30, and linear polarizer 34) are embedded within the optical system (e.g., either between lens elements 26-1 and 26-2 or between lens elements 26-2 and 26-3). This may protect the optical layers from damage during operation of device 10.

In the example of FIG. 2, a retarder is included over linear polarizer 16 in display 14. This example is merely illustrative. In an alternate arrangement, the retarder may be omitted from display 14 and/or an additional retarder may instead be included in lens assembly 20. The position of polarizer 34 between lens elements 26-2 and 26-3 in FIG. 2 is also merely illustrative. In an alternate arrangement, the reflective polarizer may be instead positioned between lens elements 26-1 and 26-2.

The example of FIG. 2 is merely illustrative and the lens assembly may have other arrangements if desired. A lens assembly of the type shown in FIG. 2 may be included for each eye of the viewer (e.g., a first lens assembly for the left eye and a second lens assembly for the right eye).

During operation of device 10, light from display 14 may pass through lens assembly 20 to be viewed by eyes 46 of the viewer. Light may follow multiple paths through the optical system. In a main path, shown by light ray 56, the light may exit display 14 in the negative Z-direction (e.g., with a circular polarization), pass through partially reflective layer 22 in the negative Z-direction, reflect off of reflective polarizer 30 (in the positive Z-direction), reflect off of partially reflective layer 22 (in the negative Z-direction), pass through reflective polarizer 30 (in the negative Z-direction), and pass through linear polarizer 34 (in the negative Z-direction) to reach eyes 46 of the viewer.

In a secondary path, shown by light ray 58, the light may exit display 14 in the negative Z-direction (e.g., with a circular polarization), pass through partially reflective layer 22 in the negative Z-direction, reflect off of reflective polarizer 30 (in the positive Z-direction) a first time, reflect off of partially reflective layer 22 (in the negative Z-direction) a first time, reflect off of reflective polarizer 30 (in the positive Z-direction) a second time, reflect off of partially reflective layer 22 (in the negative Z-direction) a second time, pass through reflective polarizer 30 (in the negative Z-direction), and pass through linear polarizer 34 (in the negative Z-direction) to reach eyes 46 of the viewer. The path associated with light ray 58 may sometimes be referred to as a double bounce path, as the light reflects off partially reflective layer 22 in the negative Z-direction twice (instead of once as in the main path associated with light ray 56). In general, it is undesirable for light following a double bounce path of this type to reach eyes 46 of the viewer as the light following the double bounce path may create undesirable ghost images for the viewer that compromise the user experience.

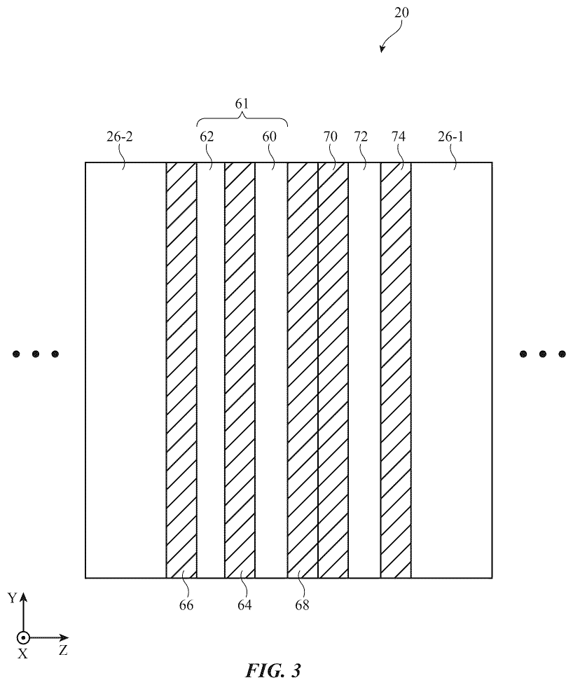

To mitigate ghost images, one or more polarizers may be incorporated within lens assembly 20 and/or display 14. An illustrative example of a lens assembly with a polarizer to reduce ghosting is shown in FIG. 3.

As shown in FIG. 3, lens assembly 20 may include polarizer 61 interposed between first lens 26-1 and second lens 26-2. Polarizer 61 may include quarter wave plate 60 and half wave plate 62. The slow axis of quarter wave plate 60 may be aligned at 15° (e.g., 15° relative to the Y-axis), as an example. Half wave plate 62 may have a slow axis that is offset from the slow axis of quarter wave plate 60 by a desired angle, such as 60°, 90°, 45°, between 30° and 60°, or another suitable amount. In an illustrative embodiment, the slow axis of quarter wave plate 60 may be aligned at 15° relative to the Y-axis, and the slow axis of half wave plate 62 may be aligned at 75°. In general, by incorporating polarizer 61, including quarter wave plate 60 and half wave plate 62, between first lens 26-1 and second lens 26-2, ghosting may be reduced while maintaining a high transmission (e.g., a low retardation) through lens assembly 20.

Lens assembly 20 may also include multiple adhesive layers, such as adhesive layers 64, 68, and 74, between first lens 26-1 and second lens 26-2. Adhesive layers 64, 68, and 74 may be formed from pressure-sensitive adhesive (PCA), optically clear adhesive (OCA), and/or any other suitable adhesive. Lens assembly 20 may also include other layers, such as interlayers 70 and 72 between first lens 26-1 and second lens 26-2. In an illustrative embodiment, interlayer 72 may be a hard coat layer, and interlayer 70 may be a dielectric layer, such as a silicon oxide layer. This arrangement is merely illustrative. In general, any suitable layers may be incorporated between first lens 26-1 and polarizer 61.

In the example of FIG. 3, polarizer 61 is provided between first lens 26-1 and second lens 26-2. If desired, the stackup of FIG. 3, including polarizer 61, may replace the layers between first lens 26-1 and second lens 26-2 in FIG. 2, including reflective mirror 22 and adhesive 32-1. By replacing reflective mirror 22 with polarizer 61, double-bounces may be further reduced (e.g., because polarizer 61 may reflect less light that follows path 58 of FIG. 2). If desired, however, polarizer 61 may be included between first lens 26-1 and second lens 26-2 in addition to some or all of the layers between first lens 26-1 and second lens 26-2 in FIG. 2.

Although polarizer 61 has been shown as being incorporated between first lens 26-1 and second lens 26-2, this arrangement is merely illustrative. In some embodiments, polarizer 61 may be incorporated between second lens 26-2 and third lens 26-3 of FIG. 2. For example, the stackup of FIG. 3, including polarizer 61, may replace the layers between second lens 26-2 and third lens 26-3 in FIG. 2, including quarter wave plate 28, reflective polarizer 30, linear polarizer 34, and adhesive layers 32. If desired, however, polarizer 61 may be included between second lens 26-2 and third lens 26-3 in addition to one or more of the layers between second lens 26-2 and third lens 26-3 in FIG. 2. As another example, polarizer 61 may be incorporated into lens assembly 20 on an outer surface, such as surface S1 of lens 26-1 (FIG. 2). In general, by incorporating polarizer 61, including quarter wave plate 60 and half wave plate 62, within lens assembly 20, ghosting may be reduced while maintaining a high transmission (e.g., a low retardation) through lens assembly 20.

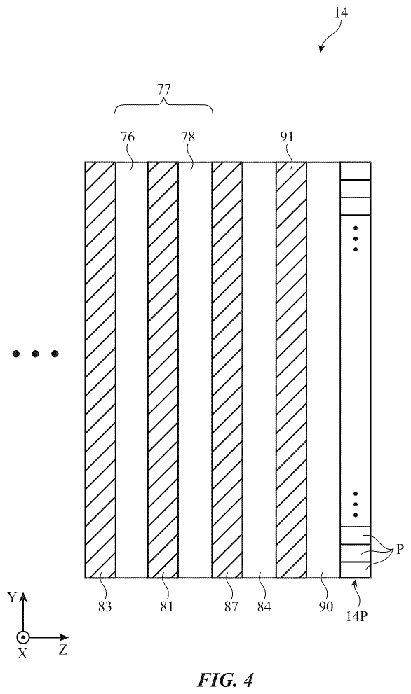

In addition to, or instead of, incorporating polarizer 61 in lens assembly 20, a polarizer and/or other optical components may be incorporated into display 14. An illustrative example is shown in FIG. 4.

As shown in FIG. 4, display 14 may include display layer 14P of pixels P and encapsulation layer 90 on display layer 14P. Encapsulation layer 90 may be formed from polymer, glass, sapphire, or another suitable material, and may cover display layer 14P.

Polarizer 77, including quarter wave plate 76 and half wave plate 78, may overlap display layer 14P in display 14. The slow axis of quarter wave plate 76 may be aligned at −15° (e.g., −15° relative to the Y-axis), as an example. Half wave plate 78 may have a slow axis that is offset from the slow axis of quarter wave plate 76 by a desired angle, such as 60°, 90°, 45°, between 30° and 60°, or another suitable amount. In an illustrative example, the slow axis of quarter wave plate 76 may be aligned at −15° relative to the Y-axis, and the slow axis of half wave plate 78 may be aligned at −75°.

In general, by incorporating polarizer 77, including quarter wave plate 76 and half wave plate 78, overlapping display layer 14P, ghosting may be reduced while maintaining a high transmission (e.g., a low retardation) through lens assembly 20. For example, the polarization axis of polarizer 77 in display 14 and polarizer 61 in lens assembly 20 (FIG. 3) may be aligned (e.g., polarizer 77 may have an opposite polarity of polarizer 61) to provide for a high transmission while minimizing ghosting.

Display 14 may also include multiple adhesive layers, such as adhesive layers 81, 83, and 87, on and between polarizer 77. Adhesive layers 81, 83, and 87 may be formed from pressure-sensitive adhesive (PCA), optically clear adhesive (OCA), and/or any other suitable adhesive.

In addition to, or instead of, incorporating polarizer 77 in display 14, geometric phase lens (GPL) 84 may overlap display layer 14P in display 14. GPL 84 may redirect light from the display layer 14P to change the angle of the emitted light. The light redirecting layer may redirect light by different amounts in different portions of the display to account for the focusing properties of lens assembly 20 and optimize the device performance.

For example, light at the bottom edge of the display in FIG. 2 may be redirected downwards (e.g., at an angle of 45° or another suitable angle in the −Y and −Z quadrant). In other words, the chief ray angle of light exiting GPL 84 at this portion of the display may be at this angle. Light at the top edge of the display in FIG. 2 may be redirected upwards (e.g., at an angle of 45° or another suitable angle in the +Y and −Z quadrant). In other words, the chief ray angle of light exiting GPL 84 at this portion of the display may be at this angle. By redirecting light at the bottom and top of display 14 in FIG. 2, the light may be redirected by lens assembly 20 to the user of device 10. In general, GPL 84 may redirect light from display layer 14P in any suitable direction to increase the amount of light that reaches the user of device 10. Meanwhile, light at the center of the display may not be substantially redirected by the GPL 84.

To summarize, GPL 84 may selectively redirect light from the display to account for the focusing properties of the lens assembly 20 included in the electronic device. The degree and direction to which light is redirected varies as a function of position across the light redirecting layer. For example, the light redirection may be at a minimum (e.g., 0 degrees) at the center of the display. With increasing distance from the center of the display, the light may be redirected by a greater amount away from the center of the display.

GPL 84 may be a diffractive-type flat lens that includes liquid crystal. To form the GPL 84, a flat liquid crystal film may be formed on a transparent substrate (e.g., glass, plastic, etc.). The liquid crystal film may include three-dimensional patterns of liquid crystals. The liquid crystals may manipulate the polarization of optical beams passing through the liquid crystals, which modulates the geometric phase of the optical beam. The geometric phase may be modulated in a spatially varying fashion to provide desired light redirecting effects. A geometric phase lens may redirect light using polarization-dependent diffraction and therefore may be considered a diffractive-type lens.

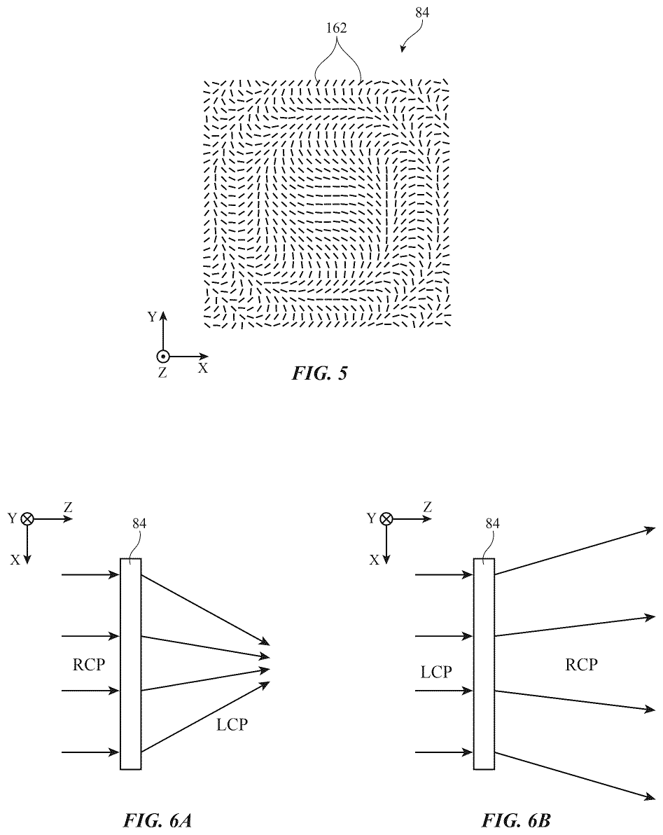

FIG. 5 is a top view of an illustrative geometric phase lens 84. As shown in FIG. 5, the geometric phase lens 84 may include liquid crystals 162 with different orientations. There may be multiple layers of liquid crystals in the geometric phase lens (e.g., stacked along the Z-axis). The liquid crystals may be formed on a transparent substrate with an intervening alignment film. An additional transparent substrate may optionally be formed over the liquid crystal film in the geometric phase lens.

The amount that light is redirected by geometric phase lens 84 may depend on the pitch (e.g., spacing) between liquid crystals of the same alignment. As shown in FIG. 5, concentric circles of liquid crystals having the same or similar orientations may be included in the geometric phase lens. The liquid crystal elements may have a larger pitch in the center of the phase lens (where light redirection is not desired) and a decreasing pitch towards the edges of the phase lens (where light redirection is desired).

Instead of, or in addition to, redirecting light based on its position on a geometric phase lens, the geometric phase lens may redirect light based on its polarity. An illustrative example is shown in FIGS. 6A and 6B.

FIGS. 6A and 6B are side views of an illustrative geometric phase lens showing how the geometric phase lens may redirect light. In the example of FIG. 6A, geometric phase lens 84 may receive incident light that is right-hand circularly polarized (RCP). This type of light may be focused to a focal point (e.g., f>0) by the geometric phase lens. The output light may be left-hand circularly polarized (LCP). This light may be referred to as a +1 order image.

In contrast, when the geometric phase lens receives incident light that is left-hand circularly polarized (LCP), as in FIG. 6B, the light may be spread (e.g., f<0) by the geometric phase lens. The output light may be right-hand circularly polarized (RCP). This light may be referred to as a −1 order image.

Therefore, if the incident light received by the geometric phase lens is all left-hand circular polarized, the light will be spread (as in FIG. 6B). If the incident light received by the geometric phase lens is all right-hand circular polarized, the light will be focused (as in FIG. 6A). If the incident light received by the geometric phase lens is linearly polarized or unpolarized, approximately half of the light will be spread (as in FIG. 6B) and approximately half of the light will be focused (as in FIG. 6A). In other words, two separate images (e.g., a +1 order image and a −1 order image) will be produced by the geometric phase lens. The example of RCP light being focused and LCP light being spread in FIGS. 6A and 6B is merely illustrative. The reverse arrangement may instead be used, with LCP light being focused and RCP light being spread.

The example of forming the geometric phase lens using liquid crystal is merely illustrative. In another possible embodiment, the geometric phase lens may be formed using a metasurface. The metasurface may include shaped nanostructures that modify the phase of incident light. The nanostructures may have a thickness of less than 200 nanometers, less than 100 nanometers, less than 50 nanometers, less than 20 nanometers, less than 10 nanometers, etc. The nanostructures may have a longest dimension (e.g., length) of less than 1 micron, less than 2 microns, less than 0.5 microns, less than 0.1 microns, etc.).

The geometric phase lens shown herein may have the advantage of being flat (e.g., with planar upper and lower surfaces that are parallel to the surface of the display panel) and may be very thin. The geometric phase lens therefore adds minimal volume and weight to the device. The thickness of the active layer (e.g., the liquid crystal layer) in the geometric phase lens may be less than 20 microns, less than 10 microns, less than 5 microns, less than 3 microns, less than 1 micron, between 1 and 10 microns, greater than 1 micron, etc. The total thickness of the geometric phase lens (including the transparent substrate, one or more alignment layers, an optional additional substrate, etc.) may be less than 10 microns, less than 20 microns, less than 50 microns, less than 100 microns, less than 500 microns, between 10 and 100 microns, greater than 10 microns, greater than 30 microns, etc.

Returning to FIG. 4, GPL 84 may overlap display layer 14P and be interposed between display layer 14P and polarizer 77. GPL 84 may be attached to encapsulation layer 90 using adhesive 91, which may be a PSA, OCA, or other suitable adhesive. GPL 84 may be coupled to polarizer 77 without any air gaps using adhesive 87. Alternatively, polarizer 77 may be applied directly to GPL 84 (e.g., without adhesive), or GPL 84 may be separated from polarizer by an air gap.

Although the example of FIG. 4 shows GPL 84 interposed between polarizer 77 and display layer 14P, this arrangement is merely illustrative. In some embodiments, polarizer 77 may be interposed between GPL 84 and display layer 14P.

The stackup of FIG. 4 in display 14 may replace the stackup of display 14 of FIG. 2, including linear polarizer 16 and/or quarter wave plate 18. However, this is merely illustrative. In some embodiments, polarizer 77 and/or GPL 84 may be incorporated in display 14 with linear polarizer 16 and/or quarter wave plate 18.

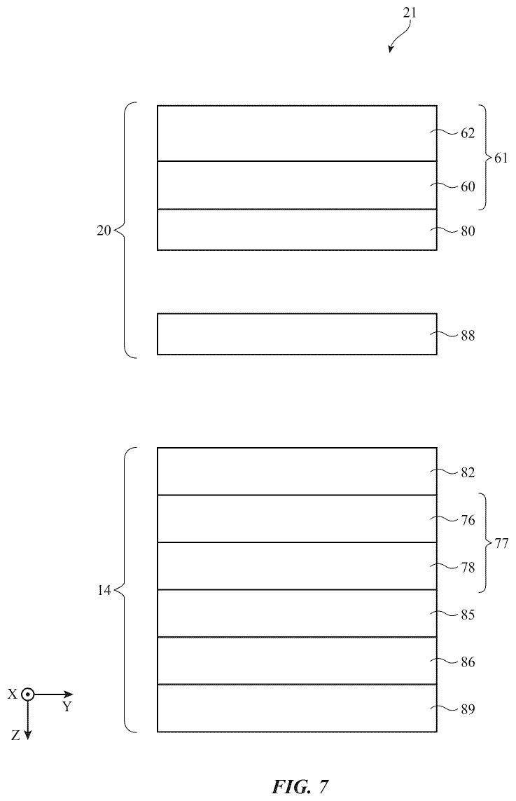

Polarizers 61 and 77 may form strain-insensitive retarders. In particular, the retarders may have a uniform ellipticity (e.g., an ellipticity with at least 90% uniformity, at least 95% uniformity, or at least 99% uniformity, as examples), when stretched during three-dimensional forming (e.g., when applied to a three-dimensional substrate, such as a lens). The retarders formed by polarizers 61 and 77 may have negative dispersion, allowing for operation across broad wavelengths. In addition to incorporating polarizers 61 and 77, it may be desirable to include other optical layers. An illustrative example is shown in FIG. 7.

As shown in FIG. 7, display 14 may include polarizer 77, including quarter wave plate 76 and half wave plate 78, and lens assembly 20 may include polarizer 61, including quarter wave plate 60 and half wave plate 62. Polarizer 61 may be formed between two lenses in lens assembly 20, as shown in FIG. 3, and polarizer 77 may overlap a display layer, as shown in FIG. 4.

Polarizer 61 and/or polarizer 77 may form a retarder. In particular, quarter wave plate 60 and/or quarter wave plate 76 may have a retardation of 140 nm, of greater than 100 nm, of between 125 nm and 175 nm, or of less than 200 nm, as examples. Half wave plate 62 and/or half wave plate 78 may have a retardation of 280 nm, of greater than 200 nm, of between 250 nm and 300 nm, or of less than 350 nm, as examples. Due to the use of polarizer 61 and polarizer 77 with aligned polarization axes (e.g., opposite polarizations), light passing through display 14 and lens assembly 20 may exhibit a near-zero ellipticity drop (e.g., a drop of less than 10%, less than 5%, or less than 1%, as examples), while being retarded by polarizer 61 and polarizer 77.

In addition to polarizer 61, lens assembly 20 may include positive C-plate 80 between polarizer 61 and display 14. Similarly, display 14 may include positive C-plate 82 between polarizer 77 and lens assembly 20. Positive C-plates 80 and 82 may compensate for off-angle retardation shifts (e.g., off-angle shifts due to polarizers 77 and 61). In other words, without C-plates 80 and 82, off-axis light passing through polarizers 61 and 77 may have an off-axis polarization as compared with on-axis light, reducing the amount of light that passes out of display 14 and lens assembly 20. The incorporation of C-plates 80 and 82 increases the amount of light that passes out of display 14 and lens assembly 20.

Display 14 may also include linear polarizer 89, negative B-plate 86, and positive B-plate 85. Linear polarizer 89 may have a pass-axis aligned with the Y-axis, as an example. Negative B-plate 86 and positive B-plate 85 may both have a slow axis of 90° (e.g., relative to the pass-axis of linear polarizer 89) or another suitable angle. Together, linear polarizer 89, negative B-plate 86, and positive B-plate 85 may polarize the light prior to reaching polarizer (retarder) 77.

Half mirror 88 may be incorporated in lens assembly 20 between C-plate 80 and display 14. In some embodiments, half mirror 88 may be applied to surface S1 of first lens 26-1 (FIG. 2). However, this is merely illustrative. In general, half mirror 88 may be applied to any suitable surface in lens assembly 20. Half mirror 88 may be, for example, a metal mirror coating or other mirror coating such as a dielectric multilayer coating with a 50% transmission and a 50% reflection (or another similar transmission and reflection split). Half mirror 88 may sometimes be referred to as partially reflective mirror 88.

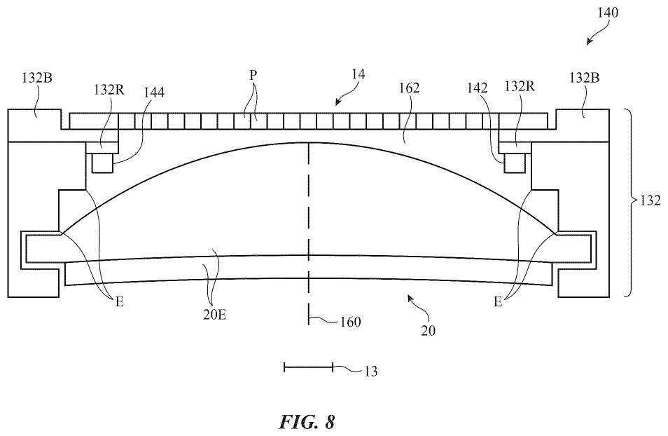

In addition to, or instead of, incorporating polarizers 61 and 77 and/or other optical films in lens assembly 20 and display 14, lens assembly and display 14 may be mounted in an optical module that is coated with a low-visible-reflectance-and-low-infrared-reflectance coating. An illustrative example is shown in FIG. 8.

As shown in FIG. 8, optical module 140 may have support structures for display 14 and lens assembly 20 such as lens barrel 132 (also referred to as support 132 or support structure 132 herein). During operation, lens assembly 20 may be used to provide an image from pixels P of display 14 to eye box 13 along optical axis 160. When a user's eye is located in eye box 13, the user may view the image from display 14.

During the operation of device 10, it may be desirable to gather information on the eyes of a user located in eye boxes 13. One or more cameras such as camera 142 of FIG. 8 and one or more light sources such as light-emitting diodes 144 may be located in interior region 162 of optical module 140 between lens assembly 20 and display 14. Light-emitting diodes 144 may extend in a partial or full ring around the perimeter of display 14 (e.g., light-emitting diodes 144 may be mounted on a ring-shaped flexible circuit that extends in a rectangular ring shape, oval ring shape, and/or other ring shape surrounding optical axis 160). There may be one, at least two, at least four, at least six, fewer than 20, fewer than 10 or other suitable number of light-emitting diodes 144 (and/or other light sources such as lasers).

Light from light-emitting diodes 144 may illuminate the user's eyes in eye boxes such as eye box 13 of FIG. 8. The light provided by light-emitting diodes 144 may include visible light and/or infrared light. Camera 142 may be sensitive at corresponding wavelengths of light. In an illustrative configuration, one or more of light-emitting diodes 144 may emit light at a first wavelength (e.g., 850 nm, at least 740 nm, at least 830 nm, less than 900 nm, less than 1050 nm, and/or other suitable infrared wavelength), and one or more of light-emitting diodes 144 may emit light at a second wavelength that is longer than the first wavelength (e.g., 940 nm, at least 830 nm, at least 850 nm, at least 900 nm, less than 1000 nm, less than 1050 nm, at least 740 nm, and/or other suitable infrared wavelength). The light at the second wavelength may serve as gaze tracking illumination. The light at the first wavelength may illuminate the user's eyes during iris scanning operations (e.g., on start-up of device 10). Other types of infrared and/or visible light illumination may be provided by light-emitting diodes 144, if desired. The use of illumination at first and second wavelengths is illustrative.

The use of infrared light at the first wavelength in illuminating eye box 13 during iris scanning may help ensure that the eyes of the user are illuminated sufficiently to capture a clear iris image (eye image) during image capture operations with camera 142 (which is sensitive to light at the first wavelength). In an illustrative configuration, iris scan illumination is provided during initial start-up operations of device 10 (e.g., so that camera 142 can capture an eye image such as an iris scan or other biometric identification information). This allows device 10 to authenticate a user before the user is permitted to use device 10 and/or access information associated with the user's account. To ensure satisfactory contrast when capturing iris scans, the light at the first wavelength may be relatively close to the edge of the visible spectrum at 740 nm (e.g., 850 nm).

Some users may be able to faintly observe light at the first wavelength. Light at the second wavelength may be completely invisible to all users, allowing light at the second wavelength to be used continuously or nearly continuously for gaze tracking operations (e.g., after start-up operations). During gaze tracking operations, light-emitting diodes 144 may be used to provide gaze tracking illumination to eye boxes 13 while camera 142 captures eye images such as pupil images and/or eye images containing direct reflections of light-emitting diodes from the user's eyes (sometimes referred to as glints).

The support structures for optical module 140 may be formed from one or more supporting members. For example, one or more ring-shaped members may form the sides of support 132 surrounding lens assembly 20. The support structures of module 40 (e.g., lens barrel 132) may, if desired, have a ring-shaped member that helps support display 14 (see, e.g., ring-shaped display bezel 132B, which may be attached to other portions of support 132 using adhesive, fasteners such as screws, welds, etc.). Electrical components such as camera(s) 142 and light-emitting diode(s) 144 may be supported using a ring-shaped cover. For example, cover ring 132R may have openings that receive respective electrical components. Light-emitting diodes 144 may, as an example, be mounted on a printed circuit substrate. Cover ring 132R may have through-hole openings arranged around some or all of the periphery of cover ring 132R. Each through-hole opening may receive a respective optical component (e.g., a respective light-emitting diode 144) and these optical components may be coupled to the cover ring using adhesive (e.g., adhesive with low-visible-light reflectance and sufficient infrared transmittance to allow emitted light from each light-emitting diode 144 to pass).

During operation of device 10, display 14 may emit stray visible light and/or stray visible light from display 14 may reflect from lens assembly 20 (e.g., a partial mirror on the innermost surface of lens assembly 20) onto the interior surfaces of support 132. Illumination from light-emitting diodes 144 may also potentially strike support 132 directly or after reflecting from lens assembly 20. Stray visible light from display 14 can interfere with the user's ability to view images from display 14 satisfactorily. Stray eye illumination (e.g., stray infrared illumination from light-emitting diodes 144 at the first and/or second wavelengths) can interfere with the ability of camera 142 to capture satisfactory eye images (e.g., for biometric authentication and/or gaze tracking).

To suppress undesired visible and infrared stray light in interior 160, one or more surfaces of support 132 in interior 162 may be provided with a low-reflectance coating (e.g., a coating with a reflectance of less than 1%, less than 2%, less than 5%, between 1% and 6%, or another suitable reflectance from 380 nm to 1000 nm or other suitable wavelengths). The coating may be formed by anodizing support 132, electrodepositing light-absorbing material into anodization pores on support 132, and etching support 132 to create surface roughness on the pores and/or by otherwise treating the surface of support 132 to form a coating that exhibits low visible light reflection and low infrared light reflection. Any or all of the surfaces of the support structures in optical module 140 that are potentially exposed to stray visible and/or infrared light may be provided with the low-reflectance coating (e.g., display bezel 132R, light-emitting diode cover ring 132R, and/or other portions of support 132 may be provided with the low-reflectance coating). This may be accomplished by forming bezel 132R, ring 132R, and/or other portions of support 132 from aluminum members or other structures that may be provided with a low-visible-reflectance-and-low-infrared-reflectance coating (e.g., a low-reflectance anodized coating).

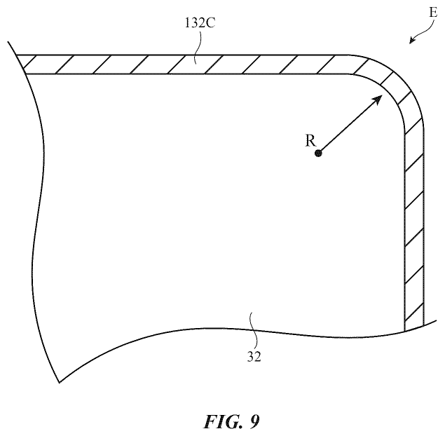

In the illustrative configuration of FIG. 8, support 132 has a cylindrical shape characterized by a longitudinal axis that is aligned with and/or parallel to optical axis 160. The walls of support 132 extend in a ring around axis 160 and may have one or more steps (sometimes referred to as shelf structures) characterized by step edges (shelf edges) E. Step edges E may be formed where the inner surfaces of support 132 that extend horizontally in FIG. 8 (with surface normals perpendicular to optical axis 160) meet with the inner surfaces of support 132 that extend vertically in FIG. 8 (with surface normals parallel to optical axis 160). Anodization operations tend to produce surface pores that extend parallel to the surface normal of the surface being anodized. There is therefore a risk that edges E will not be well covered by an anodized coating layer if edges E are sharp. As shown in FIG. 9, edges E may be provided with rounded (curved) cross-sectional profiles. As an example, each shelf edge E may be provided with a curved (rounded) cross-sectional shape of radius R, where the value of R is 0.5 mm, 0.3 to 2 mm, at least 0.1 mm, at least 0.25 mm, less than 3 mm, less than 1.5 mm, less than 0.8 mm, or other suitable value. The use of rounded edges E helps ensure that low-reflectance coating 132C will extend uniformly across edges E and thereby helps ensure that edges E will exhibit low reflectance.

The thickness of coating 132C may be 30 microns, at least 1 micron, at least 10 microns, at least 20 microns, at least 40 microns, at least 200 microns, less than 1000 microns, less than 300 microns, less than 120 microns, less than 75 microns, or less than 40 microns (as examples). Coating 132C may include black paint or ink (e.g., polymer containing black colorant such as pigment and/or dye), may include a carbon-nanotube-based coating, may include a black anodized layer, may include electroplated material, may include roughened surfaces formed by sand blasting, walnut blasting, chemical etching, machining (e.g., grinding, sanding, etc.), laser exposure, and/or other suitable surface roughening techniques. Low-reflectance material (e.g., chemically deposited layers, polymer layers including black colorant, etc.) may be deposited as part of an anodization process and/or may be applied separately. Multiple reflectivity reducing treatments may be applied to support 132, if desired.

In general, support 132 may be formed from any suitable unreflective structures (e.g., polymer or metal with black paint or other low-reflectance black polymer material such as polymer containing black pigment and/or black dye). If desired, support 132 or other coated structures may be formed from magnesium plated with aluminum, aluminum magnesium, aluminum zirconium, magnesium, plastic, steel, stainless steel, carbon fiber, composites, etc. If barrel 132 or other coated structures include magnesium, the magnesium may be conversion coated or finished (such as using micro-arc oxidation (MAO)) to protect against corrosion, if desired. The black pain or other low-reflectance black polymer material may then be applied over the coated/finished magnesium.

Coating 138C may have less than 4%, less than 3.5%, or less than 5% reflectivity, as examples, at visible wavelengths (e.g., 380-760 nm) and less than 4%, less than 5%, less than 3.5% reflectivity, as examples, at infrared wavelengths (e.g., 760-1400 nm). However, these reflectivity values are merely illustrative. For example, coating 138C may have a reflectivity of 1.5% or less across visible wavelengths, a reflectivity of less than 1% across visible wavelengths, a reflectivity of 3% or less across visible wavelengths, or any other desired reflectivity. Similarly, coating 138C may have a reflectivity of 1% or less across infrared wavelengths, a reflectivity of 1.5% or less across infrared wavelengths, a reflectivity of 3% or less across infrared wavelengths, or any other desired reflectivity. In this way, coating 132C may form a low-visible-reflectance-and-low-infrared-reflectance coating on support 132.

Additionally or alternatively, coating 132C may exhibit both low specular reflections and low diffuse reflections. For example, coating 132C may exhibit specular reflections of less than 0.2%, less than 0.1%, less than 0.05%, less than 0.03%, or less than 0.015%, as examples. Coating 132C may exhibit diffuse reflections of less than 3.5%, less than 1%, less than 0.75%, or less than 0.5%, as examples. In this way, coating 132C may have low reflectivity across both visible and infrared wavelengths and may exhibit low specular and diffuse reflections.

By incorporating coating 132C on one or more surfaces of optical module 140 (FIG. 8), the contrast of display 14 when viewed from eye box 13 may be increased. In particular, stray light from display 14 and/or other optical components may be absorbed, rather than reflected to eye box 13, increasing the contrast of display 14.

Although FIG. 9 shows coating 132C on support 132, this is merely illustrative. Coating 132C may be formed on any desired surface of head-mounted device 10. Moreover, if electronic device 10 is another device, such as a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, an accessory (e.g., earbuds, a remote control, a wireless trackpad, etc.), or other electronic equipment, a coating may be formed on a housing or another support structure of electronic device 10. In particular, electronic device 10 may have internal components in a housing that separates an interior of electronic device 10 from an exterior.

The arrangements of lens elements described herein are merely illustrative. If desired, one or more lens elements may be omitted if desired. For example, an asymmetric catadioptric lens module may include only two lens elements or only one lens element. All of the lens elements in the asymmetric catadioptric lens module may be asymmetric or at least one but not all of the lens elements in the asymmetric catadioptric lens module may be asymmetric.

The foregoing is merely illustrative and various modifications can be made to the described embodiments. The foregoing embodiments may be implemented individually or in any combination.

What is claimed is:

1. An electronic device, comprising:
a display configured to produce light, wherein the display comprises a display layer, a first quarter wave plate overlapping the display layer, and a first half wave plate interposed between the first quarter wave plate and the display layer; and
a lens assembly that receives the light from the display, wherein the lens assembly comprises:
a first lens,
a second lens,
a second half wave plate interposed between the first lens and the second lens, and
a second quarter wave plate interposed between the second half wave plate and the first lens.

2. The electronic device of claim 1, wherein the first lens is interposed between the second lens and the display.

3. The electronic device of claim 2, wherein the lens assembly further comprises:
a third lens, wherein the first and second lenses are interposed between the third lens and the display;
a third quarter wave plate interposed between the second lens and the third lens;
a linear polarizer interposed between the third quarter wave plate and the third lens; and
a reflective polarizer interposed between the third quarter wave plate and the linear polarizer.

4. The electronic device of claim 2, wherein the display comprises a first polarization axis and the lens assembly comprises a second polarization axis that is aligned with the first polarization axis.

5. The electronic device of claim 2, wherein the display further comprises:
a geometric phase lens interposed between the display layer and the first quarter wave plate.

6. The electronic device of claim 5, wherein the geometric phase lens has a center and an edge, the geometric phase lens is configured to redirect the light from the display by a first amount at the center of the geometric phase lens, and the geometric phase lens is configured to redirect the light from the display by a second amount that is different than the first amount at the edge of the geometric phase lens.

7. The electronic device of claim 6, wherein the geometric phase lens comprises a liquid crystal film.

8. The electronic device of claim 5, further comprising:
a support, wherein the display and the lens assembly are mounted in the support, and the support comprises a low-visible-reflectance-and-low-infrared-reflectance coating.

9. The electronic device of claim 8, wherein the low-visible-reflectance-and-low-infrared-reflectance coating is configured to reflect less than 4% of light across visible and infrared wavelengths.

10. The electronic device of claim 9, wherein the low-visible-reflectance-and-low-infrared-reflectance coating is configured to exhibit specular reflections of less than 0.2% and diffuse reflections of less than 3.5%.

11. The electronic device of claim 9, wherein the low-visible-reflectance-and-low-infrared-reflectance coating is configured to exhibit specular reflections of less than 0.05% and diffuse reflections of less than 0.75%.

12. An optical module for a head-mounted device, the optical module comprising:
a support including a low-visible-reflectance-and-low-infrared-reflectance coating;
a display mounted in the support and configured to produce light, wherein the display comprises a display layer, a half wave plate overlapping the display layer, and a quarter wave plate overlapping the display layer; and
a lens assembly that receives the light from the display.

13. The optical module of claim 12, wherein the low-visible-reflectance-and-low-infrared-reflectance coating is configured to reflect less than 4% of light across visible and infrared wavelengths.

14. The optical module of claim 13, wherein the low-visible-reflectance-and-low-infrared-reflectance coating is configured to exhibit specular reflections of less than 0.2% and diffuse reflections of less than 3.5%.

15. The optical module of claim 12, wherein the display further comprises:
a geometric phase lens that overlaps the display layer.

16. The optical module of claim 15, wherein the half wave plate is a first half wave plate, the quarter wave plate is a first quarter wave plate, and the lens assembly comprises:
a first lens;
a second lens;
a second half wave plate between the first lens and the second lens; and
a second quarter wave plate between the first lens and the second lens.

17. The optical module of claim 16, wherein the first lens is interposed between the display and the second lens, and the second quarter wave plate is interposed between the second half wave plate and the first lens.

18. The optical module of claim 17, wherein the lens assembly further comprises a first positive C-plate on the second quarter wave plate, and the display further comprises:
a second positive C-plate on the first quarter wave plate;
a positive B-plate between the first half wave plate and the display; and
a negative B-plate between the positive B-plate and the display.

19. An optical module for a head-mounted device, the optical module comprising:
a support including a low-visible-reflectance-and-low-infrared-reflectance coating;
a display mounted in the support and configured to produce light, wherein the display comprises a display layer, a first half wave plate overlapping the display layer, and a first quarter wave plate overlapping the display layer; and
a lens assembly that receives the light from the display, wherein the lens assembly comprises:
a first lens,
a second lens, wherein the first lens is interposed between the second lens and the display,
a third lens, wherein the second lens is interposed between the third lens and the first lens,
a second half wave plate between the first lens and the second lens, and
a second quarter wave plate between the first lens and the second lens.

20. The optical module of claim 19, wherein the display comprises a first polarization axis and the lens assembly comprises a second polarization axis that is aligned with the first polarization axis.
